(19) United States
(12) Patent Application Publication
(10) Pub. No.: US 2017/0147517 A1
(43) Pub. Date: May 25, 2017

(54) DIRECT MEMORY ACCESS SYSTEM USING AVAILABLE DESCRIPTOR MECHANISM AND/OR PRE-FETCH MECHANISM AND ASSOCIATED DIRECT MEMORY ACCESS METHOD

(71) Applicant: MEDIATEK INC., Hsin-Chu (TW)

(72) Inventors: Shin-Shiun Chen, Taipei City (TW); Yi-Wen Chien, Taoyuan City (TW); Yao-Chun Su, Hsinchu City (TW); Chih-Kang Lin, Taipei City (TW)

(21) Appl. No.: 15/221,589

(22) Filed: Jul. 27, 2016

Related U.S. Application Data
(60) Provisional application No. 62/259,028, filed on Nov. 23, 2015.

(51) Int. Cl. G06F 13/28; G06F 13/16; G06F 13/42; G06F 13/40

(52) U.S. Cl. CPC G06F 13/28; G06F 13/4022; G06F 13/1673; G06F 13/4282

(57) ABSTRACT

A direct memory access (DMA) system is implemented in an electronic device that communicates with a host device via a communication bus, and includes an available descriptor notification circuit and a DMA controller. The available descriptor notification circuit indicates whether at least one valid descriptor is available in the host device. The available descriptor notification circuit is set by at least the host device. The at least one valid descriptor records DMA data transfer control information. The DMA controller fetches the at least one valid descriptor from the host device when the available descriptor notification circuit indicates that the at least one valid descriptor is available in the host device, and refers to the at least one valid descriptor fetched from the host device to perform a DMA data transfer between the electronic device and the host device.

### CROSS REFERENCE TO RELATED APPLICATIONS

This application claims the benefit of U.S. provisional application No. 62/259,028, filed on Nov. 23, 2015 and incorporated herein by reference.

### BACKGROUND

The disclosed embodiments of the invention relate to a data transfer scheme, and more particularly, to a direct memory access (DMA) system using an available descriptor scheme and/or a pre-fetch scheme and an associated DMA method.

A network switch is a computer networking device that links different devices including one source device and one or more destination devices. For example, the network switch receives an ingress packet generated from a source device connected to it, and transmits an egress packet derived from the received ingress packet only to one or more destination devices for which the received packet is meant to be received. In general, the network switch has a packet buffer for buffering packet data of packets received from ingress ports, and forwards the packets stored in the packet buffer through egress ports. A network switch is an electronic device programmed by a host driver running on a host device. In some cases, packets in the network switch may be re-directed to a host device for certain processing, and packets in the host device may be forwarded to the network switch for transmission. Hence, there is a need for an innovative packet data transfer scheme for efficiently transferring packets between a host device and a network switch.

### SUMMARY

In accordance with exemplary embodiments of the invention, a direct memory access (DMA) system using an available descriptor scheme and/or a pre-fetch scheme and an associated DMA method are proposed to solve the above-mentioned problem.

According to a first aspect of the present invention, an exemplary direct memory access (DMA) system is disclosed. The exemplary DMA system is implemented in an electronic device that communicates with a host device via a communication bus, and includes an available descriptor notification circuit and a DMA controller. The available descriptor notification circuit is arranged to indicate whether at least one valid descriptor is available in the host device, wherein the available descriptor notification circuit is set by at least the host device, and the at least one valid descriptor records DMA data transfer control information. The DMA controller is arranged to fetch the at least one valid descriptor from the host device when the available descriptor notification circuit indicates that the at least one valid descriptor is available in the host device, and refer to the at least one valid descriptor fetched from the host device to perform a DMA data transfer between the electronic device and the host device.

According to a second aspect of the present invention, an exemplary direct memory access (DMA) system is disclosed. The exemplary DMA system is implemented in an electronic device that communicates with a host device via a communication bus, and includes a pre-fetch buffer and a DMA controller. The pre-fetch buffer is arranged to store one or more pre-fetched valid descriptors. The DMA controller is arranged to refer to a first valid descriptor fetched from the host device to perform a DMA data transfer between the electronic device and the host device, and further arranged to pre-fetch at least one second valid descriptor from the host device to the pre-fetch buffer before the DMA data transfer is finished, wherein each valid descriptor records DMA data transfer control information.

According to a third aspect of the present invention, an exemplary direct memory access (DMA) method is disclosed. The DMA method is employed by an electronic device that communicates with a host device via a communication bus, and includes: utilizing an available descriptor notification circuit to indicate whether at least one valid descriptor is available in the host device, wherein the available descriptor notification circuit is set by at least the host device, and the at least one valid descriptor records DMA data transfer control information; when the available descriptor notification circuit indicates that the at least one valid descriptor is available in the host device, fetching the at least one valid descriptor from the host device; and referring to the at least one valid descriptor fetched from the host device to perform a DMA data transfer between the electronic device and the host device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device with direct memory access capability according to an embodiment of the present invention.

FIG. 2 is a diagram illustrating the concept of the proposed available descriptor mechanism.

FIG. 3 is a diagram illustrating another electronic device with direct memory access capability according to an embodiment of the present invention.

FIG. 4 is a diagram illustrating a cross-descriptor data transfer between a host device and an electronic device according to an embodiment of the present invention.

FIG. 5 is a diagram illustrating a first pre-fetch scheme according to an embodiment of the present invention.

FIG. 6 is a diagram illustrating a second pre-fetch scheme according to an embodiment of the present invention.

FIG. 7 is a diagram illustrating a third pre-fetch scheme according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

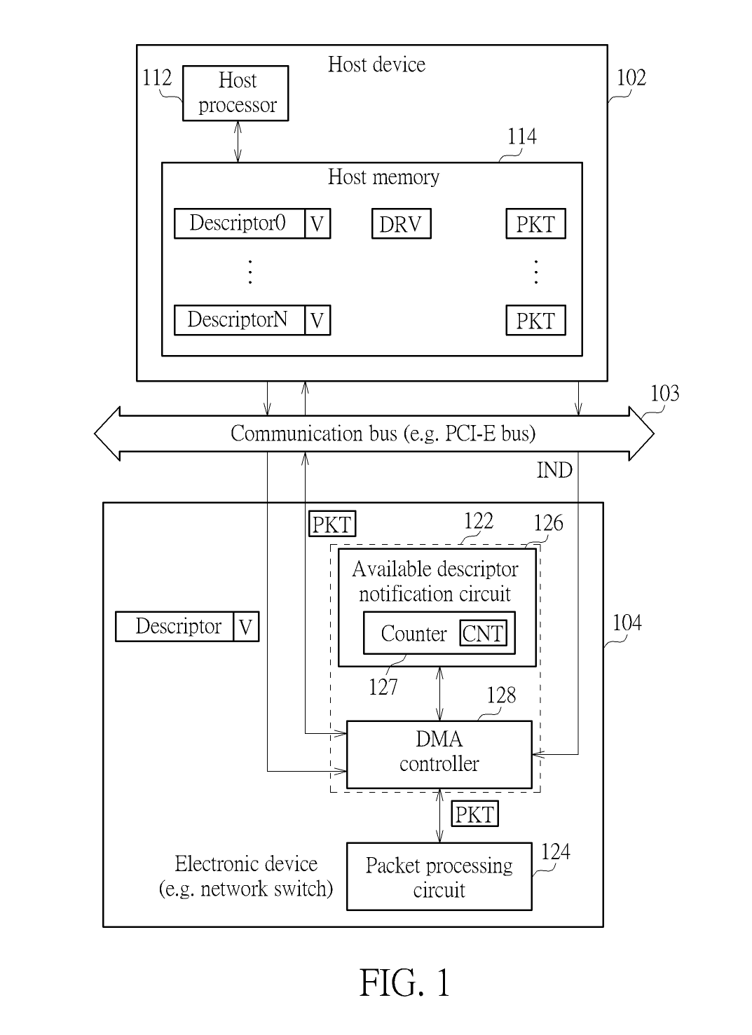

FIG. 1 is a diagram illustrating an electronic device with direct memory access (DMA) capability according to an embodiment of the present invention. In this embodiment, a host device 102 communicates with an electronic device 104 via a communication bus 103. By way of example, but not limitation, the electronic device 104 may be a network switch, and the communication bus 103 may be a Peripheral Component Interconnect Express (PCI-E) bus. In practice, the electronic device 104 may be any DMA device that can be managed by the host device 102 via the communication bus 103, and/or the communication bus 103 may be implemented using any communication protocol. The host device 102 includes a host processor 112 and a host memory 114. The electronic device 104 includes a direct memory access (DMA) system 122 and a packet processing circuit 124. The packet processing circuit 124 may process packets PKT before the packets PKT are forwarded to destination devices (not shown). The DMA system 122 includes circuits such as an available descriptor notification circuit 126 and a DMA controller 128. It should be noted that only the circuits associated with the present invention are shown in FIG. 1. In practice, the DMA system 122 may include other circuit(s) to achieve other functions.

As for the host device 102, it is arranged to load and execute a host driver DRV to control DMA data transfer between the host device 102 and the electronic device 104. For example, the host device 102 prepares descriptors Descriptor0-DescriptorN in the host memory 114, where each descriptor includes DMA data transfer control information such as a source address, a destination address, a data length, etc. In a PCI-E DMA application, there is one valid bit V in a descriptor. When the host driver DRV has prepared all the information for the descriptor, it sets the valid bit V by using a first predetermined value (e.g., a logic high value “1”). When the DMA controller 128 consumes the descriptor, it clears the valid bit V by using a second predetermined value (e.g., a logic low value “0”).

In one DMA data transfer design, an electronic device polls the valid bit V until it is set, and then the electronic device fetches the valid descriptor from the host device to do the DMA data transfer. However, a large number of PCI-E polling requests decreases the PCI-E bus utilization (i.e., wastes the PCI-E bandwidth), which leads to a huge performance drop. To solve this problem, the present invention proposes an available descriptor mechanism that can significantly reduce the memory read (MRd) transaction layer packets (TLPs) used for polling valid bits of descriptors and accordingly improve the PCI-E bus utilization. Further details of the proposed available descriptor mechanism are described as below.

The available descriptor notification circuit 126 is arranged to indicate whether at least one valid descriptor is available in the host device 102. When the available descriptor notification circuit 126 indicates that at least one valid descriptor is available in the host device 102, the DMA controller is operative to fetch the at least one valid descriptor from the host device 102. Next, the DMA controller 128 refers to the at least one valid descriptor fetched from the host device 102 to perform DMA data transfer between the electronic device (e.g., network switch) 104 and the host device 102. In accordance with the proposed available descriptor mechanism, the host device 102 actively sets the available descriptor notification circuit 126 when at least one valid descriptor is available in the host memory 114. The DMA controller 128 can know the availability of valid descriptors on the host device 102 by checking the available descriptor notification circuit 126. Since the available descriptor notification circuit 126 is a local circuit of the electronic device 104, there is no need for the electronic device 104 to issue polling requests to the host device 102 via the communication bus (e.g., PCI-E bus) 103. In this way, the bus utilization can be improved greatly.

In this embodiment, the available descriptor notification circuit 126 can be implemented using a counter 127. The counter 127 is arranged to maintain a counter value CNT indicative of the number of valid descriptors available in the host device 102. Hence, the DMA controller 128 monitors the counter value CNT to determine if at least one valid descriptor is available in the host device 102. When the counter value CNT indicates that the number of valid descriptors available in the host device 102 is a non-zero value (i.e., the host device 102 has valid descriptor (s) in the host memory 114 now), the DMA controller 128 is operative to fetch valid descriptor (s) from the host device 122.

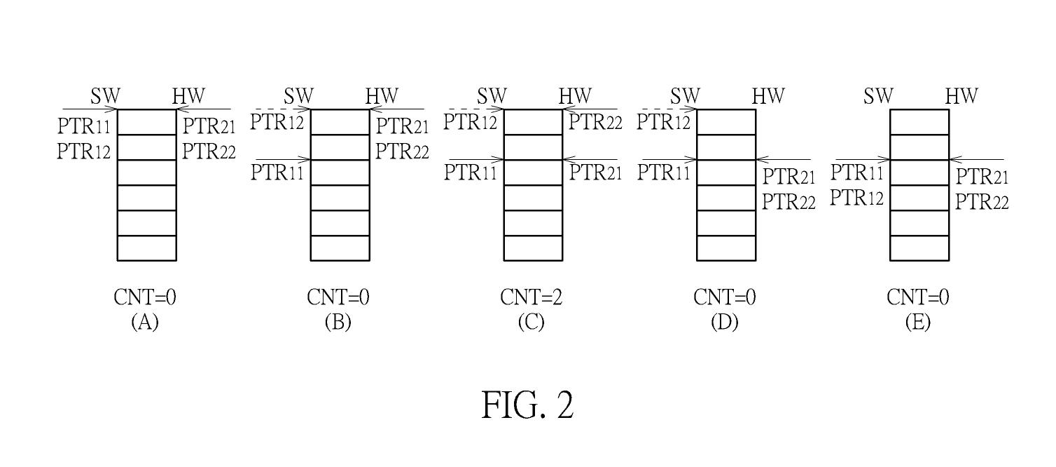

FIG. 2 is a diagram illustrating the concept of the proposed available descriptor mechanism. The host driver DRV running on the host processor 112 is a software (SW) module, and maintains a descriptor enqueue pointer PTR₁₁ and a descriptor dequeue pointer PTR₁₂. The DMA controller 128 is a hardware (HW) component, and maintains a descriptor enqueue pointer PTR₂₁ and a descriptor dequeue pointer PTR₂₂. The host memory 114 may be configured to have a queue allocated therein for buffering descriptors prepared by the host driver DRV running on the host processor 112. Initially, it is assumed that there is no valid descriptor available in the host memory 114. Hence, as illustrated in the sub-diagram (A) of FIG. 2, descriptor enqueue pointers PTR₁₁, PTR₂₁ and descriptor dequeue pointers PTR₁₂, PTR₂₂ are located at the first queue entry. In addition, the counter 127 is initialized to record the counter value CNT equal to 0. After the host driver DRV running on the host processor 112 prepares two valid descriptors in the queue, the descriptor enqueue pointer PTR₁₁ is moved downwards, as illustrated in the sub-diagram (B) of FIG. 2.

In addition, the host driver DRV running on the host processor 112 sends an indication value IND to the DMA controller 128 via the communication bus 103, where the indication value IND is indicative of the number of valid descriptors newly added. In this embodiment, IND=2. As illustrated in the sub-diagram (C) of FIG. 2, the DMA controller 128 instructs the counter 127 to adjust the counter value CNT in response to the indication value IND. For example, CNT=CNT+IND. Hence, the counter 127 records the counter value CNT that is updated to 2. Further, the DMA controller 128 refers to the indication value IND to move the descriptor enqueue pointer PTR₂₁ downwards, as illustrated in the sub-diagram (C) of FIG. 2.

Since the counter value CNT indicates that the host device 102 has two newly added valid descriptors, the DMA controller 128 is operative to automatically fetch each of the newly added valid descriptors and move the descriptor dequeue pointer PTR₂₂ downwards. The DMA controller 128 does not stop fetching the newly added valid descriptors until the descriptor dequeue pointer PTR₂₂ is aligned with the descriptor enqueue pointer PTR₂₁. Further, the DMA controller 128 instructs the counter 127 to adjust the counter value CNT each time the DMA controller 128 finishes fetching one valid descriptor from the host device 112. For example, CNT=CNT−1. As illustrated in the sub-diagram (D) of FIG. 2, the counter value CNT is decreased to an initial value (e.g., 0) after two newly added valid descriptors have been sequentially fetched from the host device 102.

After two newly added valid descriptors have been sequentially fetched from the host device 102, the DMA controller 128 updates valid bits in the fetched descriptors. In one exemplary design, the host driver DRV running on the host processor 112 can poll the valid bits of the fetched descriptors in the electronic device 104 to move the descriptor dequeue pointer PTR₁₂ to a correct queue entry. In another exemplary design, the host driver DRV running on the host processor 112 can wait for an interrupt triggered by the DMA controller 128 to move the descriptor dequeue pointer PTR₁₂ to a correct queue entry. As illustrated in the sub-diagram (E) of FIG. 2, the host driver DRV running on the host processor 112 moves the descriptor dequeue pointer PTR₁₂ downwards, such that the descriptor dequeue pointer PTR₁₂ is aligned with the descriptor enqueue pointer PTR₁₁ at the end of the DMA data transfer operation of the two descriptors.

As mentioned above, the host driver DRV running on the host processor 112 actively writes the indication value IND to the DMA system 122 (particularly, the DMA controller 128). Because a write command issued from the host device 102 for writing the indication value IND is a posted command for the communication bus (e.g., PCI-E bus) 103, the host driver DRV running on the host processor 112 has little impact on the system performance when the available descriptor mechanism is adopted.

As known, the long input/output (I/O) latency for the PCI-E protocol limits the performance of the packet data transfer if the network devices do the DMA data transfers in the blocking way. That is, the network device needs to wait for arrival of the read data of a previous read request before issuing a new read request via the PCI-E bus. Hence, when the network device does the DMA data transfers in the blocking way, the network device needs to wait for an end of the data transfer of the previous descriptor before issuing a new PCI-E request belonging to a next descriptor. Since the PCI-E bus has long read latency, fetching a next descriptor only when obtaining the read data of a current descriptor (i.e., using a DMA controller to handle descriptors one by one) will lead to a huge performance drop. To solve this problem, the present invention proposes a pre-fetch mechanism that can pre-fetch descriptors in the background and then perform a cross-descriptor data transfer to hide the long read latency of the communication bus. Further details of the proposed pre-fetch mechanism are described as below.

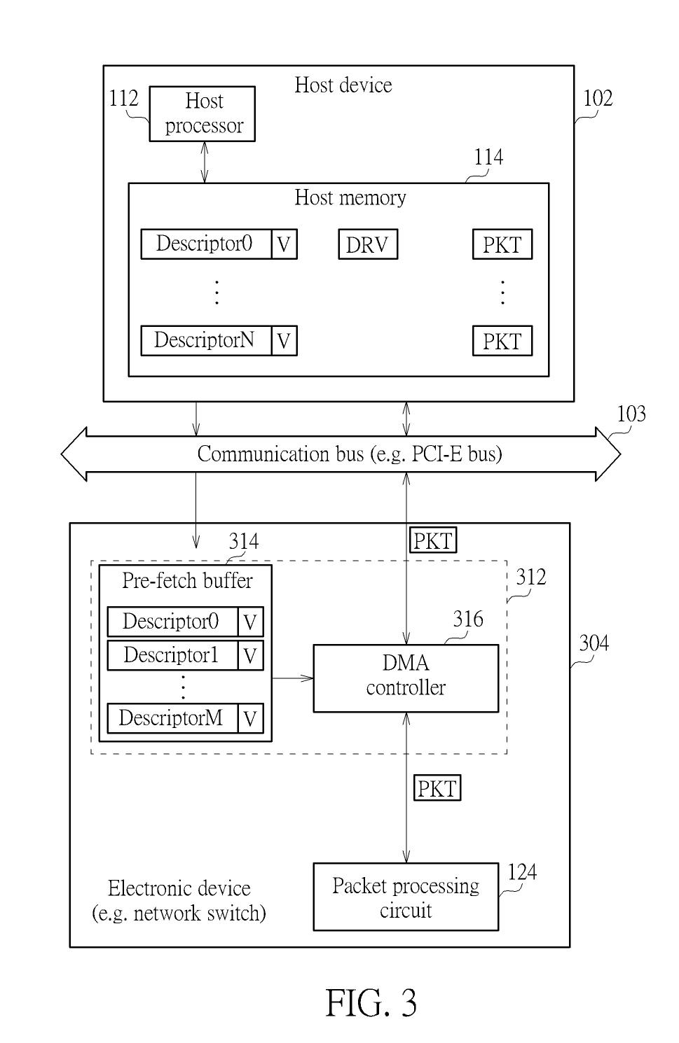

FIG. 3 is a diagram illustrating another electronic device with direct memory access (DMA) capability according to an embodiment of the present invention. In this embodiment, the host device 102 communicates with an electronic device 304 via the communication bus 103. By way of example, but not limitation, the electronic device 304 may be a network switch, and the communication bus 103 may be a Peripheral Component Interconnect Express (PCI-E) bus. In practice, the electronic device 304 may be any DMA device that can be managed by the host device 102 via the communication bus 103, and/or the communication bus 103 may be implemented using any communication protocol. In this embodiment, the electronic device 304 includes the packet processing circuit 124 arranged to process packets PKT to be forwarded to one or more destination devices (not shown), and further includes a direct memory access (DMA) system 312 having circuits such as a pre-fetch buffer 314 and a DMA controller 316.

The host device 102 is arranged to load and execute a host driver DRV to control DMA data transfer between the host device 102 and the electronic device 304. For example, the host device 102 prepares descriptors Descriptor0-DescriptorN in the host memory 114, where each descriptor include DMA data transfer control information such as a source address, a destination address, a data length, etc. In a PCI-E DMA application, there is one valid bit V in the descriptor. When the host driver DRV has prepared all the information for the descriptor, it sets the valid bit V by using a first predetermined value (e.g., a logic high value “1”). When the DMA controller 316 consumes the descriptor, it clears the valid bit V by using a second predetermined value (e.g., a logic low value “0”).

To hide the long read latency of the communication bus (e.g., PCI-E bus) 103, a pre-fetch mechanism is employed by the electronic device (e.g., network switch) 304. The pre-fetch buffer 314 is arranged to store one or more pre-fetched valid descriptors (e.g., Descriptor0-DescriptorM, where N≧M). The DMA controller 316 is arranged to refer to a first valid descriptor fetched from the host device 102 to perform a DMA data transfer between the electronic device 304 and the host device 102, and is further arranged to pre-fetch at least one second valid descriptor (e.g., at least one of Descriptor0-DescriptorN) from the host device 102 to the pre-fetch buffer 314 before the DMA data transfer associated with the first valid descriptor is finished. In other words, the electronic device 304 can pre-fetch the next descriptor from the host memory 114 to its internal pre-fetch buffer 314, and can also do the DMA data transfer associated with the current descriptor at the same time. When the DMA data transfer associated with the current descriptor is finished, the electronic device 304 can directly handle the next current descriptor in its internal pre-fetch buffer 314 rather than the host memory 114. In this way, the bubble time resulting from the long read latency of the communication bus 103 can be avoided.

Further, since at least one second valid descriptor (e.g., at least one of Descriptor0-DescriptorN) is pre-fetched and stored in the pre-fetch buffer 314 during the DMA data transfer associated with the first valid descriptor, the DMA controller 316 can perform the DMA data transfer across the descriptor boundary between the first valid descriptor and the at least one second valid descriptor to further improve the throughput of the communication bus 103. For example, there are two descriptors (e.g., one first valid descriptor and one second valid descriptor) which indicate DMA data transfer control information of two different packets. Because there is the pre-fetch buffer 314 that stores the pre-fetched second valid descriptor in advance, the DMA controller 316 can refer to the second valid descriptor to issue a read request to the host device 102 for fetching data associated with the second valid descriptor before all data requested by the first valid descriptor is received by the DMA controller 316.

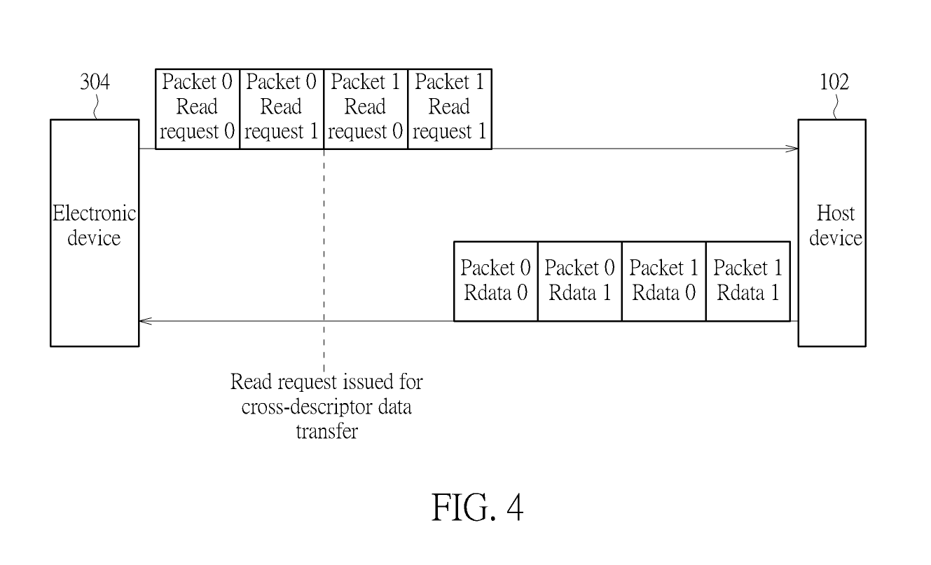

FIG. 4 is a diagram illustrating a cross-descriptor data transfer between a host device and an electronic device according to an embodiment of the present invention. As shown in FIG. 4, the electronic device 304 can issue the read request to fetch data from the host device 102 based on the next descriptor without waiting for the read data Rdata of the current descriptor. In other words, read requests of successive descriptors are outstanding requests. Hence, the overhead of the communication bus 103 that is caused by the long read latency of the communication bus 103 can be reduced, and the utilization of the communication bus 103 can be increased. In this way, the system performance can be improved greatly.

It should be noted that the network application can benefit from the proposed pre-fetch mechanism. In general, packet sizes of most packets are smaller than 1.5 KB (kilobytes). Hence, the host driver DRV running on the host processor 112 does not assign a large buffer size for a descriptor to improve the management efficiency of the host memory 114. However, it is possible that the DMA controller 316 needs to transfer a jumbo packet whose packet size is large (e.g., 9 KB). Due to the limitation of the buffer size for each descriptor, the DMA controller 316 needs to do the scatter-gather function to use multiple descriptors to handle different parts of the same jumbo packet. The proposed cross-descriptor data transfer scheme can handle this kind of jumbo packet to improve the system performance.

As mentioned above, the DMA controller 316 can pre-fetch valid descriptor (s) prepared by the host device 102 and store the pre-fetched valid descriptor (s) in the pre-fetch buffer 314 for later use. The DMA controller 316 may employ one of three proposed pre-fetch schemes to decide how many descriptors should be fetched from the host memory 114 and when to fetch the descriptors from the host memory 114. Further details of the proposed pre-fetch schemes are described as below.

For clarity and simplicity, the following assumes that the communication bus 103 is the PCI-E bus, the descriptor size is 64 B (Bytes), and the maximum payload size of the communication bus (e.g., PCI-E bus) 103 is 256 B. Further, the DMA controller 316 may know the number of valid descriptors available in the host device 102 by using the typical polling mechanism or the proposed available descriptor mechanism.

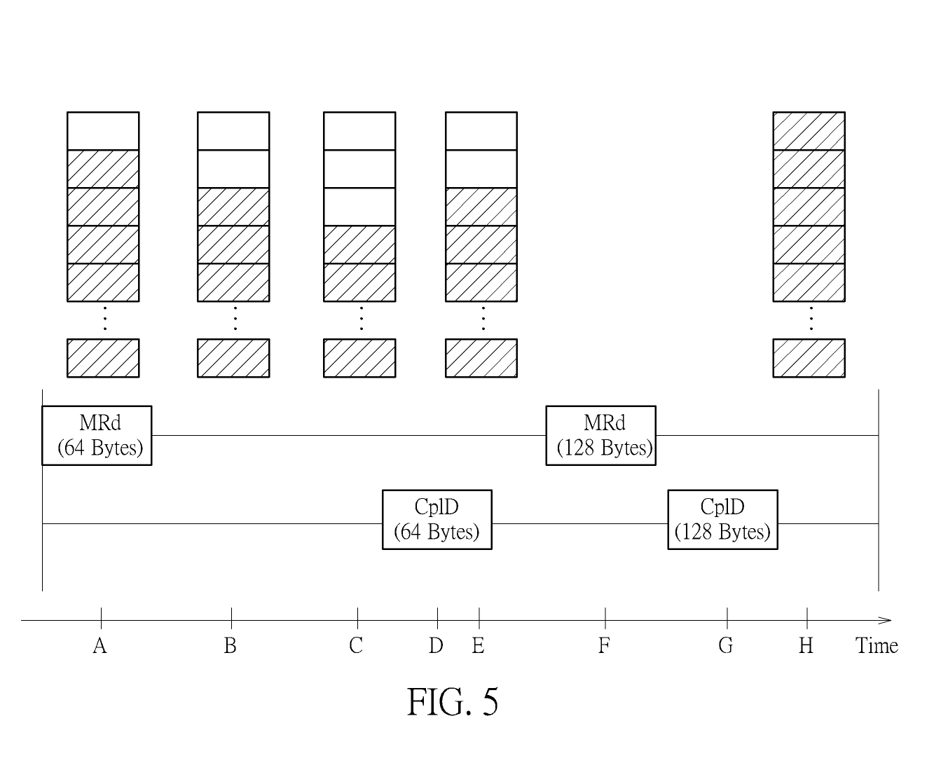

FIG. 5 is a diagram illustrating a first pre-fetch scheme according to an embodiment of the present invention. In accordance with the first pre-fetch scheme, the DMA controller 316 does not issue multiple outstanding memory read (MRd) requests and does not care the maximum payload size of the PCI-E protocol. At the time instance A, the pre-fetch buffer 314 has a free space available for accommodating one 64-byte descriptor. Assuming that the size of valid descriptors available in the host device 102 is not smaller than the size of the free space available in the pre-fetch buffer 314, the DMA controller 316 issues one MRd request to request/pre-fetch one 64-byte valid descriptor from the host device 102. At the time instance B, a completion with data (CplD) TLP for the MRd request issued at the time instance A is not returned from the host device 102 yet, and the DMA controller 316 has consumed one more descriptor to perform one DMA data transfer between the host device 102 and the electronic device 304. Hence, there is a free space available for accommodating two descriptors in the pre-fetch buffer 314 at the time instance B. At the time instance C, the CplD for the MRd request issued at the time instance A is not returned from the host device 102 yet, and the DMA controller 316 has consumed one more descriptor to perform one DMA data transfer between the host device 102 and the electronic device 304. Hence, there is a free space available for accommodating three descriptors in the pre-fetch buffer 314 at the time instance C.

At the time instance D, the DMA controller 316 gets the CplD TLP with one requested 64-byte valid descriptor that is generated from the host device 102 in response to the MRd request issued at the time instance A. At the time instance E, the DMA controller 316 stores one 64-byte valid descriptor pre-fetched from the host device 102 into the pre-fetch buffer 314. Hence, there is a free space available for accommodating two descriptors in the pre-fetch buffer 314 at the time instance E.

The CplD TLP for the MRd request issued at the time instance A is returned, and the pre-fetch buffer 314 has a free space available for accommodating two 64-byte descriptors now. Assuming that the size of valid descriptors available in the host device 102 is not smaller than the size of the free space available in the pre-fetch buffer 314, the DMA controller 316 issues one MRd request to request/pre-fetch two 64-byte valid descriptors from the host device 102 at the time instance F. At the time instance G, the DMA controller 316 gets the CplD TLP with two requested 64-byte valid descriptors that is generated from the host device 102 in response to the MRd request issued at the time instance F. At the time instance H, the DMA controller 316 stores two 64-byte valid descriptors pre-fetched from the host device 102 into the pre-fetch buffer 314. Hence, the pre-fetch buffer 314 is filled with descriptors that will be consumed by the DMA controller 316 for DMA data transfer.

In summary, when the pre-fetch buffer 314 has a new free space available for accommodating at least one first valid descriptor at a first time instance (e.g., time instance A shown in FIG. 5), the DMA controller 316 issues a first read request to the host device 102 for pre-fetching the at least one first valid descriptor from the host device 102; and when the pre-fetch buffer 314 has a new free space available for accommodating at least one second valid descriptor at a second time instance (e.g., time instance E shown in FIG. 5), the DMA controller 316 issues a second read request to the host device 102 for pre-fetching the at least one second valid descriptor from the host device 102. The first read request and the second read request are consecutive read requests issued from the DMA controller 316 at different time instances. In accordance with the first pre-fetch scheme, the first read request and the second read request are not outstanding requests, and the DMA controller 316 does not consider the maximum payload size of the PCI-E protocol to determine when to issue the first read request and the second read request, that is, the DMA controller 316 does not control the pre-fetched descriptor size based on the free space in the pre-fetch buffer 314 and the maximum payload size parameter of the PCI-E bus.

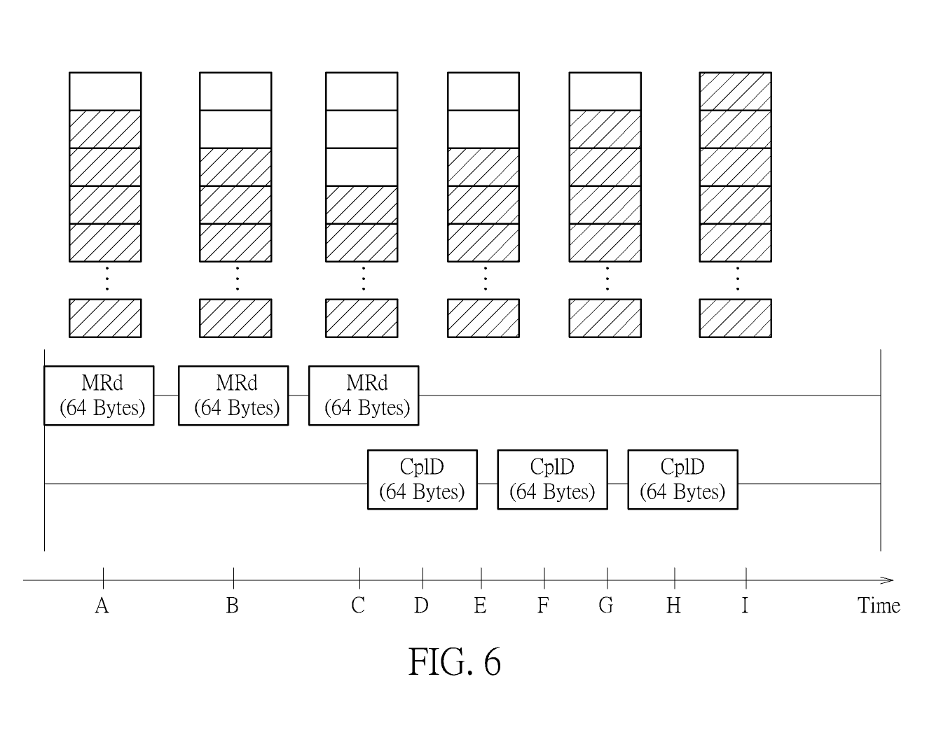

FIG. 6 is a diagram illustrating a second pre-fetch scheme according to an embodiment of the present invention. In accordance with the second pre-fetch scheme, the DMA controller 316 issues multiple outstanding memory read (MRd) requests, and does not care the maximum payload size of the PCI-E protocol. At the time instance A, the pre-fetch buffer 314 has a free space available for accommodating one 64-byte descriptor. Assuming that the size of valid descriptors available in the host device 102 is not smaller than the size of the free space available in the pre-fetch buffer 314, the DMA controller 316 issues one MRd request to request/pre-fetch one 64-byte valid descriptor from the host device 102.

At the time instance B, a CplD TLP for the MRd request issued at the time instance A is not returned from the host device 102 yet, and the DMA controller 316 has consumed one more descriptor to perform one DMA data transfer between the host device 102 and the electronic device 304. Therefore, the pre-fetch buffer 314 can accommodate one more 64-byte descriptor. Assuming that the size of valid descriptors available in the host device 102 is not smaller than the size of the free space available in the pre-fetch buffer 314, the DMA controller 316 issues a new MRd request to request/pre-fetch another 64-byte valid descriptor from the host device 102.

At the time instance C, the CplD TLP for the MRd request issued at the time instance A and the CplD TLP for the MRd request issued at the time instance B are not returned from the host device 102 yet, and the DMA controller 316 has consumed one more descriptor to perform one DMA data transfer between the host device 102 and the electronic device 304. Therefore, the pre-fetch buffer 314 can accommodate one more 64-byte descriptor. Assuming that the size of valid descriptors available in the host device 102 is not smaller than the size of the free space available in the pre-fetch buffer 314, the DMA controller 316 issues a new MRd request to request/pre-fetch yet another 64-byte valid descriptor from the host device 102.

At the time instance D, the DMA controller 316 gets the CplD TLP with one requested 64-byte valid descriptor that is generated from the host device 102 in response to the MRd request issued at the time instance A. At the time instance E, the DMA controller 316 stores one 64-byte valid descriptor pre-fetched from the host device 102 into the pre-fetch buffer 314. At the time instance F, the DMA controller 316 gets the CplD TLP with one requested 64-byte valid descriptor that is generated from the host device 102 in response to the MRd request issued at the time instance B. At the time instance G, the DMA controller 316 stores one 64-byte valid descriptor pre-fetched from the host device 102 into the pre-fetch buffer 314. At the time instance H, the DMA controller 316 gets the CplD TLP with one requested 64-byte valid descriptor that is generated from the host device 102 in response to the MRd request issued at the time instance C. At the time instance I, the DMA controller 316 stores one 64-byte valid descriptor pre-fetched from the host device 102 into the pre-fetch buffer 314.

In summary, when the pre-fetch buffer 314 has a new free space available for accommodating at least one first valid descriptor at a first time instance (e.g., time instance A shown in FIG. 6), the DMA controller 316 issues a first read request to the host device 102 for pre-fetching the at least one first valid descriptor from the host device 102; and when the pre-fetch buffer 314 has a new free space available for accommodating at least one second valid descriptor at a second time instance (e.g., time instance B shown in FIG. 6), the DMA controller 316 issues a second read request to the host device 102 for pre-fetching the at least one second valid descriptor from the host device 102. The first read request and the second read request are consecutive read requests issued from the DMA controller 316 at different time instances. In accordance with the second pre-fetch scheme, the first read request and the second read request are outstanding requests, and the DMA controller 316 does not consider the maximum payload size of the PCI-E protocol to determine when to issue the first read request and the second read request, that is, the DMA controller 316 does not control the pre-fetched descriptor size based on the free space in the pre-fetch buffer 314 and the maximum payload size parameter of the PCI-E bus. Since multiple-outstanding is used by the second pre-fetch scheme to hide the long PCI-E read latency, the PCI-E throughput can be greatly improved by the second pre-fetch scheme compared to the first pre-fetch scheme.

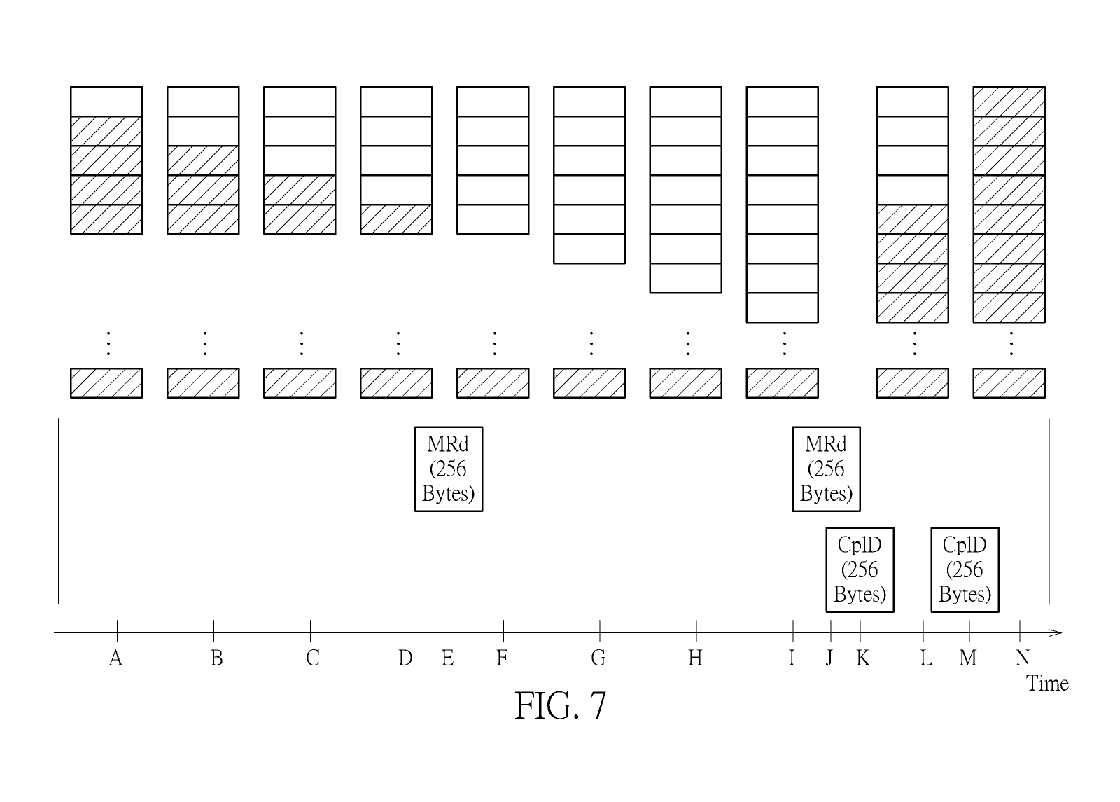

FIG. 7 is a diagram illustrating a third pre-fetch scheme according to an embodiment of the present invention. In accordance with the third pre-fetch scheme, the DMA controller 316 issues multiple outstanding memory read (MRd) requests, and does care the maximum payload size of the PCI-E protocol. At the time instance A, the pre-fetch buffer 314 has a free space available for accommodating one 64-byte descriptor. The size of the free space in the pre-fetch buffer 314, however, is smaller than one maximum payload size of the PCI-E protocol. Hence, the DMA controller 316 does not issue one MRd request to request/pre-fetch one 64-byte valid descriptor from the host device 102.

At the time instance B, the DMA controller 316 has consumed one more descriptor to perform one DMA data transfer between the host device 102 and the electronic device 304. Hence, there is a free space available for accommodating two 64-byte descriptors. The size of the free space in the pre-fetch buffer 314, however, is still smaller than one maximum payload size of the PCI-E protocol. Hence, the DMA controller 316 does not issue one MRd request to request/pre-fetch two 64-byte valid descriptors from the host device 102.

At the time instance C, the DMA controller 316 has consumed one more descriptor to perform one DMA data transfer between the host device 102 and the electronic device 304. Hence, there is a free space available for accommodating three 64-byte descriptors. The size of the free space in the pre-fetch buffer 314, however, is still smaller than one maximum payload size of the PCI-E protocol. Hence, the DMA controller 316 does not issue one MRd request to request/pre-fetch three 64-byte valid descriptors from the host device 102.

At the time instance D, the DMA controller 316 has consumed one more descriptor to perform one DMA data transfer between the host device 102 and the electronic device 304. Hence, there is a free space available for accommodating four 64-byte descriptors. The DMA controller 316 detects that the size of the free space in the pre-fetch buffer 314 is not smaller than one maximum payload size of the PCI-E protocol. Assume that the size of valid descriptors available in the host device 102 is not smaller than the size of the free space available in the pre-fetch buffer 314. At the time instance E, the DMA controller 316 issues one MRd request to request/pre-fetch four 64-byte valid descriptors from the host device 102.

At the time instance F, a CplD TLP for the MRd request issued at the time instance E is not returned from the host device 102 yet, and the DMA controller 316 has consumed one more descriptor to perform one DMA data transfer between the host device 102 and the electronic device 304. Though the pre-fetch buffer 314 can accommodate one additional 64-byte descriptor, the size of newly created free space in the pre-fetch buffer 314 is smaller than one maximum payload size of the PCI-E protocol. Hence, the DMA controller 316 does not issue a new MRd request to request/pre-fetch one 64-byte valid descriptor from the host device 102.

At the time instance G, the CplD TLP for the MRd request issued at the time instance E is not returned from the host device 102 yet, and the DMA controller 316 has consumed one more descriptor to perform one DMA data transfer between the host device 102 and the electronic device 304. Though the pre-fetch buffer 314 can accommodate two additional 64-byte descriptors, the size of newly created free space in the pre-fetch buffer 314 is still smaller than one maximum payload size of the PCI-E protocol. Hence, the DMA controller 316 does not issue a new MRd request to request/pre-fetch two 64-byte valid descriptors from the host device 102.

At the time instance H, the CplD TLP for the MRd request issued at the time instance E is not returned from the host device 102 yet, and the DMA controller 316 has consumed one more descriptor to perform one DMA data transfer between the host device 102 and the electronic device 304. Though the pre-fetch buffer 314 can accommodate three additional 64-byte descriptors, the size of newly created free space in the pre-fetch buffer 314 is still smaller than one maximum payload size of the PCI-E protocol. Hence, the DMA controller 316 does not issue a new MRd request to request/pre-fetch three 64-byte valid descriptors from the host device 102.

At the time instance I, the CplD TLP for the MRd request issued at the time instance E is not returned from the host device 102 yet, and the DMA controller 316 has consumed one more descriptor to perform one DMA data transfer between the host device 102 and the electronic device 304. Hence, there is an additional free space available for accommodating four 64-byte descriptors now. The DMA controller 316 detects that the size of newly created free space in the pre-fetch buffer 314 is not smaller than one maximum payload size of the PCI-E protocol. Assume that the size of valid descriptors available in the host device 102 is not smaller than the size of the newly created free space available in the pre-fetch buffer 314. At the time instance J, the DMA controller 316 issues a new MRd request to request/pre-fetch four 64-byte valid descriptors from the host device 102.

At the time instance K, the DMA controller 316 gets the CplD TLP with four requested 64-byte valid descriptors that is generated from the host device 102 in response to the MRd request issued at the time instance E. At the time instance L, the DMA controller 316 stores four 64-byte valid descriptors pre-fetched from the host device 102 into the pre-fetch buffer 314. At the time instance M, the DMA controller 316 gets the CplD TLP with four requested 64-byte valid descriptors that is generated from the host device 102 in response to the MRd request issued at the time instance J. At the time instance N, the DMA controller 316 stores four 64-byte valid descriptors pre-fetched from the host device 102 into the pre-fetch buffer 314.

In summary, when the pre-fetch buffer 314 has a new free space available for accommodating multiple first valid descriptors at a first time instance (e.g., time instance E shown in FIG. 7), the DMA controller 316 issues a first read request to the host device 102 for pre-fetching the multiple first valid descriptors from the host device 102; and when the pre-fetch buffer 314 has a new free space available for accommodating multiple second valid descriptors at a second time instance (e.g., time instance J shown in FIG. 7), the DMA controller 316 issues a second read request to the host device 102 for pre-fetching the multiple second valid descriptors from the host device 102. The first read request and the second read request are consecutive read requests issued from the DMA controller 316 at different time instances. In accordance with the third pre-fetch scheme, the first read request and the second read request are outstanding requests, and the DMA controller 316 considers the maximum payload size of the PCI-E protocol to determine when to issue the first read request and the second read request, that is, the DMA controller 316 controls the pre-fetched descriptor size based on the free space in the pre-fetch buffer 314 and the maximum payload size parameter of the PCI-E bus.

For example, the new free space available for accommodating the multiple first valid descriptors at the first time instance is not smaller than the maximum payload size, and the new free space available for accommodating the multiple second valid descriptors at the second time instance is not smaller than the maximum payload size. Since multiple-outstanding is used by the third pre-fetch scheme to hide the long PCI-E read latency, the PCI-E throughput can be improved by the third pre-fetch scheme compared to the first pre-fetch scheme. Further, since the maximum payload size is considered by the third pre-fetch scheme to determine when to issue one MRd request for pre-fetching descriptors from the host device 102, the number of MRd requests issued from the electronic device 304 can be reduced, and the payload size of one CplD TLP returned from the host device 102 in response to the MRd request issued from the electronic device 304 can be maximized. Compared to any of the first pre-fetch scheme and the second pre-fetch scheme, the third pre-fetch scheme can reduce more overhead of the PCI-E throughput due to minimized loss of the PCI-E bandwidth.

In the example shown in FIG. 7, one MRd request for pre-fetching multiple descriptors is issued each time a size of a free space in the pre-fetch buffer 314 that is available for accommodating new descriptors is equal to one maximum payload size of the PCI-E protocol. However, this is not meant to be a limitation of the present invention. Alternatively, one MRd request for pre-fetching multiple descriptors may be issued when a size of a free space in the pre-fetch buffer 314 that is available for accommodating new descriptors is larger than one maximum payload size of the PCI-E protocol, where multiple CplD TLPs may be returned from the host device 102 in response to one MRd request. The same objective of reducing MRd requests transmitted via the communication bus 103 and/or enlarge the payload size of one CplD TLP can be achieved.

As illustrated in FIG. 1, the electronic device 104 employs the proposed available descriptor mechanism to improve the bus utilization by reducing the polling MRd requests transmitted via the communication bus 103. As illustrated in FIG. 3, the electronic device 304 employs the proposed pre-fetch mechanism to hide the long read latency of the communication bus and minimize the loss of the bus bandwidth by using multiple-outstanding. However, these are for illustrative purposes only, and are not meant to be limitations of the present invention. For example, an electronic device (e.g., network switch) may employ the proposed available descriptor mechanism and the proposed pre-fetch mechanism to gain benefits from both of the proposed available descriptor mechanism and the proposed pre-fetch mechanism. This also falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A direct memory access (DMA) system implemented in an electronic device that communicates with a host device via a communication bus, the DMA system comprising:
an available descriptor notification circuit, arranged to indicate whether at least one valid descriptor is available in the host device, wherein the available descriptor notification circuit is set by at least the host device, and the at least one valid descriptor records DMA data transfer control information; and
a DMA controller, arranged to fetch the at least one valid descriptor from the host device when the available descriptor notification circuit indicates that the at least one valid descriptor is available in the host device, and refer to the at least one valid descriptor fetched from the host device to perform a DMA data transfer between the electronic device and the host device.

2. The DMA system of claim 1, wherein the available descriptor notification circuit comprises:
a counter, arranged to maintain a counter value indicative of a number of valid descriptors available in the host device, wherein the DMA controller monitors the counter value to determine if the at least one valid descriptor is available in the host device, and when the counter value indicates that the number of valid descriptors available in the host device is a non-zero value, the DMA controller is operative to fetch the at least one valid descriptor from the host device.

3. The DMA system of claim 2, wherein when the host device prepares the at least one valid descriptor, the host device sends an indication value indicative of a number of the at least one valid descriptor to the DMA controller, and the DMA controller instructs the counter to adjust the counter value in response to the indication value.

4. The DMA system of claim 2, wherein the DMA controller instructs the counter to adjust the counter value each time the DMA controller finishes fetching one valid descriptor from the host device.

5. The DMA system of claim 1, wherein the electronic device is a network switch.

6. A direct memory access (DMA) system implemented in an electronic device that communicates with a host device via a communication bus, the DMA system comprising:
a pre-fetch buffer, arranged to store one or more pre-fetched valid descriptors; and
a DMA controller, arranged to refer to a first valid descriptor fetched from the host device to perform a DMA data transfer between the electronic device and the host device, and further arranged to pre-fetch at least one second valid descriptor from the host device to the pre-fetch buffer before the DMA data transfer is finished, wherein each valid descriptor records DMA data transfer control information.

7. The DMA system of claim 6, wherein the DMA data transfer is to read data from the host device to the electronic device; and before all data requested by the first valid descriptor is received by the DMA controller, the DMA controller refers to the at least one second valid descriptor stored in the pre-fetch buffer to issue at least one read request to the host device.

8. The DMA system of claim 6, wherein when the pre-fetch buffer has a new free space available for accommodating the at least one second valid descriptor prepared by the host device at a first time instance, the DMA controller issues a first read request to the host device for pre-fetching the at least one second valid descriptor from the host device; when the pre-fetch buffer has a new free space available for accommodating at least one third valid descriptor prepared by the host device at a second time instance, the DMA controller issues a second read request to the host device for pre-fetching the at least one third valid descriptor from the host device; and the first read request and the second read request are consecutive read requests issued from the DMA controller.

9. The DMA system of claim 8, wherein the first read request and the second read request are not outstanding requests; and the DMA controller does not consider a maximum payload size of the communication bus to determine when to issue the first read request and the second read request.

10. The DMA system of claim 8, wherein the first read request and the second read request are outstanding requests; and the DMA controller does not consider a maximum payload size of the communication bus to determine when to issue the first read request and the second read request.

11. The DMA system of claim 8, wherein the first read request and the second read request are outstanding requests; and the DMA controller considers a maximum payload size of the communication bus to determine when to issue the first read request and the second read request.

12. The DMA system of claim 11, wherein the new free space available for accommodating the at least one second valid descriptor at the first time instance is not smaller than the maximum payload size; and the new free space available for accommodating the at least one third valid descriptor at the second time instance is not smaller than the maximum payload size.

13. The DMA system of claim 6, wherein the electronic device is a network switch.

14. A direct memory access (DMA) method employed by an electronic device that communicates with a host device via a communication bus, the DMA method comprising:
utilizing an available descriptor notification circuit to indicate whether at least one valid descriptor is available in the host device, wherein the available descriptor notification circuit is set by at least the host device, and the at least one valid descriptor records DMA data transfer control information;
when the available descriptor notification circuit indicates that the at least one valid descriptor is available in the host device, fetching the at least one valid descriptor from the host device; and
referring to the at least one valid descriptor fetched from the host device to perform a DMA data transfer between the electronic device and the host device.

15. The DMA method of claim 14, wherein utilizing the available descriptor notification circuit to indicate whether at least one valid descriptor is available in the host device comprises:
configuring the available descriptor notification circuit to have a counter arranged to maintain a counter value indicative of a number of valid descriptors available in the host device; and
monitoring the counter value to determine if the at least one valid descriptor is available in the host device, wherein fetching the at least one valid descriptor from the host device is performed when the counter value indicates that the number of valid descriptors available in the host device is a non-zero value.

16. The DMA method of claim 15, further comprising:
when the host device prepares the at least one valid descriptor, receiving an indication value indicative of a number of the at least one valid descriptor from the host device; and
adjusting the counter value maintained by the counter in response to the indication value.

17. The DMA method of claim 15, further comprising:
adjusting the counter value maintained by the counter each time fetching one valid descriptor from the host device is finished.

18. The DMA method of claim 14, wherein the electronic device is a network switch.

19. The DMA method of claim 14, wherein the at least one valid descriptor includes a first valid descriptor and at least one second valid descriptor; and fetching the at least one valid descriptor from the host device comprises:
before a first DMA data transfer performed between the electronic device and the host device according to the first valid descriptor fetched from the host device is finished, pre-fetching the at least one second valid descriptor from the host device to a pre-fetch buffer.

20. The DMA method of claim 19, wherein the first DMA data transfer is to read data from the host device to the electronic device; and referring to the at least one valid descriptor fetched from the host device to perform the DMA data transfer between the electronic device and the host device comprises:
before all data requested by the first valid descriptor is fetched via the first DMA data transfer, referring to the at least one second valid descriptor stored in the pre-fetch buffer to issue at least one read request to the host device.
